(19) United States
(12) Patent Application Publication
(10) Pub. No.: US 2025/0219809 A1
(43) Pub. Date: Jul. 3, 2025

(54) ENCRYPTION/DECRYPTION DEVICE WITH VERIFICATION MECHANISM

(71) Applicant: Nuvoton Technology Corporation, Hsinchu Science Park (TW)

(72) Inventors: Kun-Yi WU, Tainan City (TW); Yu-Shan LI, Tainan City (TW)

(21) Appl. No.: 18/989,555

(22) Filed: Dec. 20, 2024

(30) Foreign Application Priority Data
Dec. 29, 2023 (TW) 112151487

(51) Int. Cl. H04L 9/06

(52) U.S. Cl. CPC H04L 9/0631

(57) ABSTRACT

An encryption and decryption device includes a ShiftRow/InvShiftRow unit, a SubBytes/InvSubBytes unit, a dual ShiftRow/InvShiftRow unit, an encoder, a decoder, and a first verification unit. The ShiftRow/InvShiftRow unit performs a row shift/inverse row shift operation on result data to generate an input state array. The subbytes/invsubbytes unit performs a transformation on the input state array to generate an output state array. The dual ShiftRow/InvShiftRow unit performs the row shift/inverse row shift operation on dual output data to generate a dual input state array. The encoder encodes the dual input state to generate encoded data. The decoder decodes the encoded data to generate decoded data. The first verification unit verifies the mapping relationship of the decoded data and the output state array to generate a first verification signal.

### CROSS REFERENCE TO RELATED APPLICATIONS

This Application claims priority of Taiwan Patent Application No. 112151487, filed on Dec. 29, 2023, the entirety of which is incorporated by reference herein.

### BACKGROUND OF THE INVENTION

### Field of the Invention

The invention is generally related to an encryption/decryption device based on an advanced encryption standard (AES), and more particularly it is related to an encryption/decryption device that verifies whether the advanced encryption standard has been executed correctly.

### Description of the Related Art

In cryptography, the term “encryption” refers to the process of changing plaintext into incomprehensible ciphertext to protect its content. Only a device having a decryption method can restore the ciphertext to normal readable content through a decryption process. Ideally, only authorized personnel can read the information conveyed by the ciphertext. Encryption itself cannot prevent the interception of transmitted information, but it can prevent the interceptor from understanding the content of the information.

In order to prevent the encryption/decryption device from being attacked and causing ciphertext leakage, it is necessary to verify the correctness of each encryption step and decryption step to ensure the security of the encryption/decryption device.

### BRIEF SUMMARY OF THE INVENTION

The present invention proposes an encryption/decryption device having a verification mechanism, which is suitable for any implementation of byte replacement transformation. Although there are many ways to implement byte replacement transformation or inverse byte replacement transformation, the verification mechanism of the encryption/decryption device of the present invention can detect whether an error has occurred in the operation when the input value of the multiplicative inverse element (Multiplicative Inverse) is 0x0, and detect whether an error has occurred in the binary field multiplication operation in the mixed column operation and the inverse mix column operation. In addition, the verification mechanism proposed by the present invention can also protect the encryption procedure and the decryption procedure to ensure the security of the encrypted/decrypted data. Furthermore, the verification mechanism proposed by the present invention can also determine whether an error has occurred during the data transmission process, thereby improving the security during the encryption and decryption processes.

In an embodiment, an encryption and decryption device comprises a ShiftRow/InvShiftRow unit, a SubBytes/InvSubBytes unit, a dual ShiftRow/InvShiftRow unit, an encoder, a decoder, a first verification unit, and a controller. The ShiftRow/InvShiftRow unit performs a row shift/inverse row shift operation on result data to generate an input state array. The subbytes/invsubbytes unit performs a transformation on the input state array to generate an output state array. The dual ShiftRow/InvShiftRow unit performs the row shift/inverse row shift operation on dual output data to generate a dual input state array. The encoder encodes the dual input state to generate encoded data. The decoder decodes the encoded data to generate decoded data. The first verification unit verifies the mapping relationship of the decoded data and the output state array to generate a first verification signal. The controller determines whether the transformation performed by the SubbBytes/InvSubBytes unit is correct based on the first verification signal.

In another embodiment, an encryption/decryption method comprises the following steps. A row shift/inverse row shift operation is performed on result data to generate an input state array. A byte replacement/inverse byte replacement transformation is performed on the input state array to generate an output state array. The row shift/inverse row shift operation is performed on dual result data to generate a dual input state array by using a dual ShiftRow/InvShiftRow unit. The dual input state array is encoded to generate encoded data. The encoded data is decoded to generate decoded data. It is determined whether the byte replacement/inverse byte replacement transformation is correct based on the mapping relationship of the decoded data and the output state array.

In another embodiment, an encryption/decryption method comprises the following steps. A row shift/inverse row shift operation is performed on result data to generate an input state array. A byte replacement/inverse byte replacement transformation is performed on the input state array to generate an output state array. The row shift/inverse row shift operation is performed on dual result data to generate a dual input state array by using a dual ShiftRow/InvShiftRow unit. The dual input state array is encoded to generate encoded data. The encoded data is decoded to generate decoded data. A multiplied-by-2 operation is performed on the output state array to generate a multiplied-by-2 array. A divided-by-2 operation is performed on the multiplied-by-2 array to generate a multiplied-by-2-and-divided-by-2 array. It is determined whether the byte replacement/inverse byte replacement transformation is correct based on the mapping relationship of decoded data and the multiplied-by-2-and-divided-by-2 array.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram showing an encryption/decryption device in accordance with an embodiment of the present invention;

FIG. 2 is a block diagram showing a SubBytes/InvSubBytes unit in accordance with an embodiment of the present invention;

FIG. 3 is a schematic diagram showing a first verification unit in accordance with an embodiment of the present invention;

FIG. 4 is a schematic diagram showing a divide-by-2 circuit in accordance with an embodiment of the present invention;

FIG. 5 is a schematic diagram showing a second verification unit in accordance with an embodiment of the present invention;

FIG. 6 is a schematic diagram showing a third verification unit in accordance with an embodiment of the present invention;

FIG. 7 is a block diagram showing an encryption/decryption device in accordance with another embodiment of the present invention;

FIG. 8 is a block diagram showing an encryption/decryption device in accordance with yet another embodiment of the present invention;

FIG. 9 is a block diagram showing an encryption/decryption device in accordance with yet another embodiment of the present invention;

FIG. 10 is a schematic diagram showing an encoding operation and a decoding operation in accordance with an embodiment of the present invention;

FIG. 11 is a flow chart showing an encryption/decryption method in accordance with an embodiment of the present invention; and

FIG. 12 is a flow chart showing an encryption/decryption method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

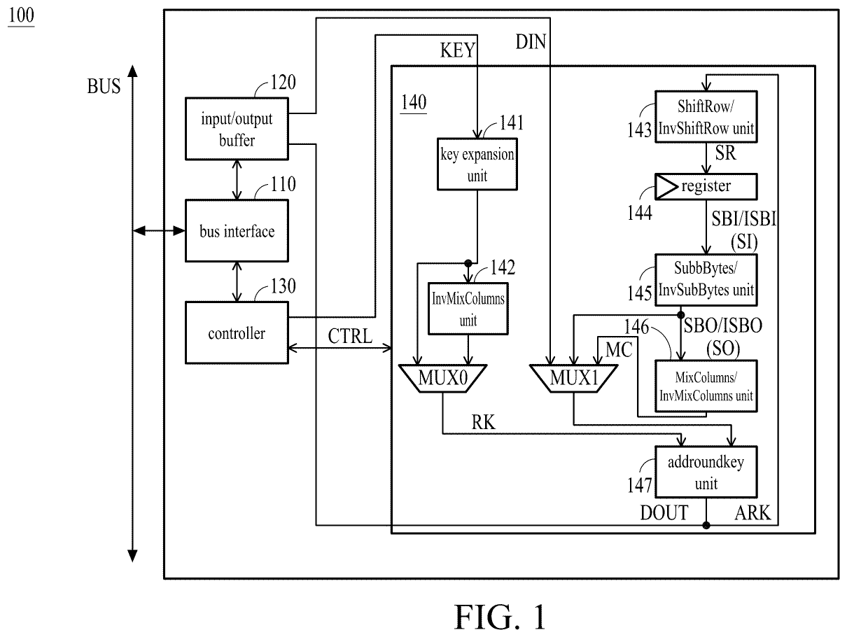

FIG. 1 is a block diagram showing an encryption/decryption device in accordance with an embodiment of the present invention. As shown in FIG. 1, the encryption/decryption device 100 includes a bus interface 110, an input/output buffer 120, a controller 130, and an encryption/decryption circuit 140. The input data DIN is temporarily stored in the input/output buffer 120 through the bus interface 110 through the bus BUS. When the bus interface 110 receives the input data DIN, the controller 130 generates the key KEY, provides the key KEY to the encryption/decryption circuit 140, and controls the encryption/decryption circuit 140 by the control signal CTRL to generate the encryption and decryption data DOUT based on the input data DIN and the key KEY.

According to some embodiments of the present invention, the encryption/decryption circuit 140 uses the advanced encryption standard (AES) to perform an encryption procedure or a decryption procedure on the input data DIN to generate the encrypted/decrypted data DOUT. As shown in FIG. 1, the encryption/decryption circuit 140 includes a key expansion unit 141, an InvMixColumns unit 142, and a first multiplexer MUX0. According to an embodiment of the present invention, when the encryption/decryption circuit 140 executes the encryption procedure, the first multiplexer MUX0 outputs the result output by the key expansion unit 141 based on the key KEY as the round key RK. According to another embodiment of the present invention, when the encryption/decryption circuit 140 executes the decryption procedure, the first multiplexer MUX0 selects the result generated by the key expansion unit 141 and the anti-mixing row unit 142 based on the key KEY, and outputs it as the round key RK.

As shown in FIG. 1, the encryption/decryption circuit 140 further includes a ShiftRow/InvShiftRow unit 143, a register 144, a SubbBytes/InvSubBytes unit 145, a MixColumns/InvMixColumns unit 146, second multiplexer MUX1, and an addroundkey unit 147.

According to an embodiment of the present invention, when the input data DIN has just been input to the encryption/decryption circuit 140, the second multiplexer MUX1 provides the input data DIN to the addroundkey unit 147, so that the addroundkey unit 147 performs a binary field addition operation on the input data DIN and the round key RK to generate the result data ARK, and the generated result data ARK is provided to the ShiftRow/InvShiftRow unit 143. According to an embodiment of the present invention, when the addroundkey unit 147 performs a binary field addition operation on the input data DIN and the round key RK, the addroundkey unit 147 performs the mutually exclusive-OR operation on the input data DIN and the round key RK to generate the result data ARK.

The ShiftRow/InvShiftRow unit 143 performs a circular shift on each row in the result data ARK to generate the shift data SR. The register 144 temporarily stores the shift data SR, and provides the shift data SR as the input status array SBI/ISBI to the SubbBytes/InvSubBytes unit 145. The SubbBytes/InvSubBytes unit 145 converts the input state array SBI/ISBI to generate the output state array SBO/ISBO.

According to an embodiment of the present invention, when the encryption/decryption circuit 140 performs the encryption procedure, the SubbBytes/InvSubBytes unit 145 performs byte replacement transformation on the input state array SBI to generate an output state array SBO. According to another embodiment of the present invention, when the encryption/decryption circuit 140 performs the decryption procedure, the SubbBytes/InvSubBytes unit 145 performs inverse byte replacement transformation on the input state array ISBI to generate the output state array ISBO. According to some embodiments of the present invention, the byte replacement transformation and the inverse byte replacement transformation are inverse functions of each other, and the byte replacement transformation and the inverse byte replacement transformation each includes a linear transformation and a non-linear transformation.

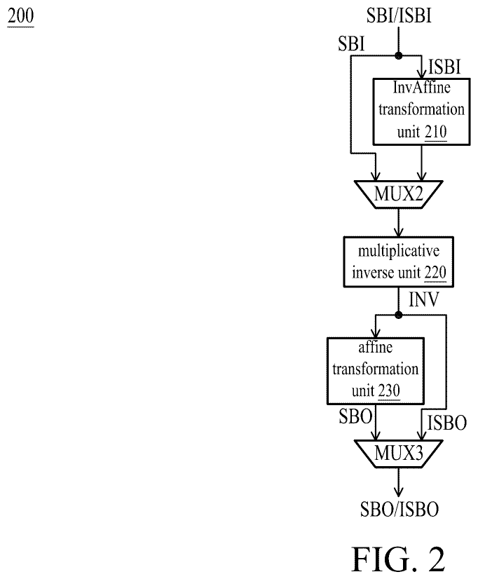

FIG. 2 is a block diagram showing a SubBytes/InvSubBytes unit in accordance with an embodiment of the present invention. As shown in FIG. 2, the SubbBytes/InvSubBytes unit 200 includes an InvAffine transformation unit 210, a third multiplexer MUX2, a multiplicative inverse unit 220, and an affine transformation unit 230, and a fourth multiplexer MUX3. According to an embodiment of the present invention, the SubbBytes/InvSubBytes unit 200 corresponds to the SubbBytes/InvSubBytes unit 145 in FIG. 1.

According to an embodiment of the present invention, when the encryption/decryption circuit 140 in FIG. 1 executes the encryption procedure, the third multiplexer MUX2 provides the input state array SBI to the multiplicative inverse unit 220, and the multiplicative inverse unit 220 performs a nonlinear transformation on the input state array SBI to generate an inverse element INV. The affine transformation unit 230 then performs an affine transformation on the inverse element INV to generate an output state array SBO. Then, the fourth multiplexer MUX3 outputs the output status array SBO.

According to another embodiment of the present invention, when the encryption/decryption circuit 140 in FIG. 1 executes the decryption procedure, the InvAffine transformation unit 210 performs the inverse affine transformation on the input state array ISBI to generate a result, and the third multiplexer MUX2 provides the result to the multiplicative inverse unit 220. The multiplicative inverse unit 220 performs a nonlinear transformation on the result of the inverse affine transformation performed by the InvAffine transformation unit 210 to generate an inverse element INV. Then, the fourth multiplexer MUX3 outputs the inverse element INV as the output state array ISBO.

According to some embodiments of the present invention, since the SubbBytes/InvSubBytes unit 200 shares the most complex multiplicative inverse unit 220 in the encryption procedure and the decryption procedure, the input state array and output state array of the encryption procedure are marked SBI and SBO respectively and the input state array and output state array of the decryption procedure are marked ISBI and ISBO respectively in the following explanation and description.

Referring to FIG. 1, the MixColumns/InvMixColumns unit 146 performs a mix-column/inverse mix column operation on the output state array SBO/ISBO to generate a mix-column/inverse mix-column array MC. The addroundkey unit 147 performs a binary field addition operation on the mix-column/inverse mix-column array MC (or the output state array SBO/ISBO) and the round key RK to generate the result data ARK. According to an embodiment of the present invention, the binary field addition operation is a mutually exclusive-OR operation. According to some embodiments of the present invention, after the ShiftRow/InvShiftRow unit 143, the register 144, the SubbBytes/InvSubBytes unit 145, the MixColumns/InvMixColumns unit 146, and the addroundkey unit 147 execute a plurality of rounds, the addroundkey unit 147 generates encrypted/decrypted data DOUT, and outputs the encrypted/decrypted data DOUT through the input/output buffer 120, the bus interface 110 and the bus BUS.

In order to ensure the correctness of the encryption and decryption procedures executed by the encryption/decryption circuit 140 and to protect the key from the differential fault analysis (DFA) method, the encryption/decryption circuit 140 needs a powerful countermeasure to detect the occurrence of errors.

As shown in FIG. 2, when performing the encryption procedure, it is assumed that the input state array SBI[7:0] and the output state array SBO[7:0] are respectively the input value and the output value of the byte SubbBytes/InvSubBytes unit 200 in the encryption procedure. The transformation performed by the multiplicative inverse unit 220 is marked as power of −1, and the affine transformation performed by the affine transformation unit 230 is marked as AT, so the input state array SBI[7:0] and the output status array SBO[7:0] are as shown in Eq. 1:

$$SBO [ 7 : 0 ] = A T ( {( SBI [ 7 : 0 ] )}^{- 1} ) \qquad ( Eq . 1 )$$

The inverse affine transformation (i.e., AT⁻¹) is performed on both sides of the equal sign of Eq. 1 to obtain Eq. 2.

$${AT}^{- 1} ( SBO [ 7 : 0 ] ) = {( SBI [ 7 : 0 ] )}^{- 1} \qquad ( Eq . 2 )$$

Next, the left and right sides of the equal sign of Eq. 2 are both multiplied by the input state array SBI[7:0] to obtain Eq. 3.

$${AT}^{- 1} ( SBO [ 7 : 0 ] ) * ( SBI [ 7 : 0 ] ) = 0 x 1 , where SBI [ 7 : 0 ] \neq 0 x 0 during encryption \qquad ( Eq . 3 )$$

$${AT}^{- 1} ( SBO [ 7 : 0 ] ) * ( SBI [ 7 : 0 ] ) = 0 x 0 , where SBI [ 7 : 0 ] = 0 x 0 during \\ \\ encryption$$

According to an embodiment of the present invention, when the input state array SBI[7:0] is 0x0, result the binary field multiplication operation must be 0x0. According to another embodiment of the present invention, when the input state array SBI[7:0] is not 0x0, the result of the binary field multiplication operation must be 0x1. However, when the input state array SBI[7:0] is 0x0, no matter the attacker inserts any fault value into AT⁻¹(SBO[7:0]), Eq. 3 is always true. In other words, Eq. 3 cannot detect the operation error that occurs when the input status array SBI[7:0] is 0x0.

In order to overcome the above shortcomings, when the input status array SBI[7:0] is 0x0, the output status array SBO[7:0] is set to 0x63 according to a lookup table. Therefore, we can modify the detection method of Eq. 3 to determine whether the input status array SBI[7:0] is 0x0. When the input status array SBI[7:0] is 0x0, it is determined whether the output status array SBO[7:0] is 0x63. When the output status array SBO[7:0] is 0x63, it means that the operation of the SubbBytes/InvSubBytes unit 200 is correct. When the output status array SBO[7:0] is not 0x63, it means that the operation of the SubbBytes/InvSubBytes unit 200 is incorrect.

When the input status array SBI[7:0] is not 0x0, determine whether the product of AT⁻¹(SBO[7:0]) and the input status array SBI[7:0] is 0x1. When the product of AT⁻¹(SBO[7:0]) and the input state array SBI[7:0] is 0x1, it indicates that the operation of the SubbBytes/InvSubBytes unit 200 is correct. When the product of AT⁻¹(SBO[7:0]) and the input state array SBI[7:0] is not 0x1, it indicates that the operation of the SubbBytes/InvSubBytes unit 200 incorrect.

The above judgment can be described as Eq. 4, where Eq. 4 is as follows:

$$( SBI [ 7 : 0 ] == 0 x 0 ) ? ( SBO [ 7 : 0 ] == 0 x 63 ) : ( A {T}^{- 1} ( SBO [ 7 : 0 ] ) * ( SBI [ 7 : 0 ] ) == 0 x 1 ) \qquad ( Eq . 4 )$$

Among them, the question mark (i.e., ?) and colon (i.e., :) in Eq. 4 are combined into a ternary operator. The formula on the left side of the question mark is the condition of the ternary operator, and the equation on the right side is the corresponding result of whether the condition of the ternary operator is established or not. When the condition is met, the equation on the left side of the colon is returned as the result. When the condition is not met, the equation on the right side of the colon is returned as the result. Therefore, when the input state array SBI[7:0] is 0x0, Eq. 4 returns the result of whether the output state array SBO[7:0] is equal to 0x63. When the input state array SBI[7:0] is not 0x0, the result of whether the result of the binary field multiplication operation is equal to 0x1 is returned. Therefore, Eq. 4 can be used to detect whether an error has occurred in the operation of the SubbBytes/InvSubBytes unit 200 during the encryption procedure.

As shown in FIG. 2, when performing the decryption procedure, it is assumed that the input state array ISBI[7:0] and the output state array ISBO[7:0] are respectively the input value and the output value of the SubbBytes/InvSubBytes unit 200 in the decryption procedure, the inverse affine transformation performed by the InvAffine transformation unit 210 is marked as AT⁻¹, and the transformation performed by the multiplicative inverse unit 220 is marked as power of −1, so the relationship between the input state array ISBI[7:0] and the output status array ISBO[7:0] is as shown in Eq. 5:

$$ISBO [ 7 : 0 ] = {( A {T}^{- 1} ( ISBI [ 7 : 0 ] ) )}^{- 1} \qquad ( Eq . 5 )$$

Both sides of the equal sign of Eq. 5 are multiplied by AT⁻¹(ISBI[7:0]) to obtain Eq. 6.

$$ISBO [ 7 : 0 ] * A {T}^{- 1} ( ISBI [ 7 : 0 ] ) = 0 x 1 , where ISBI [ 7 : 0 ] \neq 0 x 63 during decryption \qquad ( Eq . 6 )$$

$$ISBO [ 7 : 0 ] * A {T}^{- 1} ( ISBI [ 7 : 0 ] ) = 0 x 0 , where ISBI [ 7 : 0 ] = 0 x 63 during decryption$$

When the input state array ISBI[7:0] is 0x63, the result of the binary field multiplication operation must be 0x0, otherwise it must be 0x1. In addition, this patent learns from Fig. 14 in FIPS 197, Advanced Encryption Standard (AES) dated Nov. 26, 2001 that when the input status array ISBI[7:0] is 0x63, the output status array ISBO[7:0] must be 0x0. Therefore, Eq. 6 can be rewritten as Eq. 7.

$$( ISBI [ 7 : 0 ] == 0 x 63 ) ? ( ISBO [ 7 : 0 ] == 0 x 0 ) : ISBO [ 7 : 0 ] * {AT}^{- 1} ( ISBI [ 7 : 0 ] ) == 0 x 1 \qquad ( Eq . 7 )$$

As shown in Eq. 7, when the input status array ISBI[7:0] is 0x63, the comparison result of whether the output status array ISBO[7:0] is equal to 0x0 is returned. On the contrary, the returned result of whether the binary field multiplication operation result is equal to 0x1. Therefore, Eq. 7 can be used to detect whether an error has occurred in the transformation operation of the SubbBytes/InvSubBytes unit 200 during the decryption procedure.

In other words, whether an error has occurred in the transformation operation of the SubbBytes/InvSubBytes unit 145 in FIG. 1 in the encryption procedure and the decryption procedure can be determined by Eq. 4 and Eq. 7 respectively. Moreover, when the input status array ISBI[7:0] is 0x63 or the input status array SBI[7:0] is equal to 0x0, the SubbBytes/InvSubBytes unit 145 can also determines whether there is an error in the transformation operation during the encryption procedure and decryption procedure by Eq. 4 and Eq. 7. In addition, error verification methods for the MixColumns/InvMixColumns unit 146 and the addroundkey unit 147 are also needed.

It is assumed that the inverse element INV[127:0], the round key RK[127:0], and the result data ARK[127:0] generated by the multiplicative inverse unit 220 in FIG. 2 are as shown in Eq. 8. Since the MixColumns/InvMixColumns unit 146 converts in 32-bit as a unit, each 128-bit unit is divided into four set of 32-bit in Eq. 8.

$$INV [ 127 : 0 ] = \{ INV 3 [ 31 : 0 ] , INV 1 [ 31 : 0 \} , INV 2 [ 31 : 0 ] , INV 0 [ 31 : 0 ] \} \qquad ( Eq . 8 )$$

$$RK [ 127 : 0 ] = \{ RK 3 [ 31 : 0 ] , RK 1 [ 31 : 0 \} , RK 2 [ 31 : 0 ] , RK 0 [ 31 : 0 ] \}$$

$$AK [ 127 : 0 ] = \{ ARK 3 [ 31 : 0 ] , ARK 1 [ 31 : 0 \} , ARK 2 [ 31 : 0 ] , ARK 0 [ 31 : 0 ] \}$$

The 4 bytes of the inverse element INV[127:0](i.e., I0, I1, I2, I3) perform three binary field addition operations (i.e., mutually exclusive-OR operation) to form a simplified inverse element INVXi [7:0] is shown in Eq. 9.

$$INVXi [ 7 : 0 ] = ( INVi [ 31 : 24 ] ⊕ INVi [ 23 : 16 \} ⊕ INVi [ 15 : 8 ] ⊕ INVi [ 7 : 0 ] ) = I 3 ⊕ I 2 ⊕ I 1 ⊕ I 0 , where 0 < i \leq 3 \qquad ( Eq . 9 )$$

Eq. 10 performs three binary field addition operations on the 4 bytes of the round key RK[127:0](i.e. R0, R1, R2, R3) to form a simplified round key RKXi[7:0].

$$RKXi [ 7 : 0 ] = ( RKi [ 31 : 24 ] ⊕ RKi [ 23 : 16 \} ⊕ RKi [ 15 : 8 ] ⊕ RKi [ 7 : 0 ] ) = R 3 ⊕ R 2 ⊕ R 1 ⊕ R 0 , where 0 \leq i \leq 3 \qquad ( Eq . 10 )$$

Eq. 11 performs three iterations of binary field addition operations on the 4 bytes of the result data ARK[127:0](i.e., A0, A1, A2, A3) to form the simplified result data ARKXi[7:0].

$$ARKXi [ 7 : 0 ] = ( ARKi [ 31 : 24 ] ⊕ ARKi [ 23 : 16 \} ⊕ ARKi [ 15 : 8 ] ⊕ ARKi [ 7 : 0 ] ) = A 3 ⊕ A 2 ⊕ A 1 ⊕ A 0 , where 0 \leq i \leq 3 \qquad ( Eq . 11 )$$

The affine transformation performed by the affine transformation unit 230 in FIG. 2 is to perform matrix multiplication (hereinafter marked as MM operation) on the simplified inverse element INVXi[7:0] and then perform a binary field addition operation (i.e., the result of the MM operation is then performed the mutually exclusive-OR operation with 0x63). The result of the simplified inverse element INVXi[7:0] processed by the affine transformation unit 230, the MixColumns/InvMixColumns unit 146, and the round key addition unit 147 is as shown in Eq. 12.

$$A 0 = ( 0 x 2 * ( MM ( I 0 ) ⊕ 0 x 63 ) ) ⊕ ( 0 x 3 * ( MM ( I 1 ) ⊕ 0 x 63 ) ) ⊕ ( 0 x 1 * ( MM ( I 2 ) ⊕ 0 x 63 ) ) ⊕ ( 0 x 1 * ( MM ( I 3 ) ⊕ 0 x 63 ) ) ⊕ R 0 ; \qquad ( Eq . 12 )$$

$$A 1 = ( 0 x 1 * ( MM ( I 0 ) ⊕ 0 x 63 ) ) ⊕ ( 0 x 2 * ( MM ( I 1 ) ⊕ 0 x 63 ) ) ⊕ ( 0 x 3 * ( MM ( I 2 ) ⊕ 0 x 63 ) ) + ( 0 x 1 * ( MM ( I 3 ) ⊕ 0 x 63 ) ) ⊕ R 1 ;$$

$$A 2 = ( 0 x 1 * ( MM ( I 0 ) ⊕ 0 x 63 ) ) ⊕ ( 0 x 1 * ( MM ( I 1 ) ⊕ 0 x 63 ) ) + ( 0 x 2 * ( MM ( I 2 ) ⊕ 0 x 63 ) ) + ( 0 x 3 * ( MM ( I 3 ) ⊕ 0 x 63 ) ) ⊕ R 2 ;$$

$$A 3 = ( 0 x 3 * ( MM ( I 0 ) ⊕ 0 x 63 ) ⊕ ( 0 x 1 * ( MM ( I 1 ) ⊕ 0 x 63 ) ) ⊕ ( 0 x 1 * ( MM ( I 2 ) ⊕ 0 x 63 ) ) ⊕ ( 0 x 2 * ( MM ( I 3 ) ⊕ 0 x 63 ) ) ⊕ R 3 ;$$

The simplified result data ARKXi[7:0] is as shown in Eq. 13.

$$ARKXi = A 0 ⊕ A 1 ⊕ A 2 ⊕ A 3 = MM ( I 0 ) ⊕ MM ( I 1 ) ⊕ MM ( I 2 ) ⊕ MM ( I 3 ) ⊕ R 0 ⊕ R 1 ⊕ R 2 ⊕ R 3 = MM ( I 0 ⊕ I 1 ⊕ I 2 ⊕ I 3 ) ⊕ R 0 ⊕ R 1 ⊕ R 2 ⊕ R 3 \qquad ( Eq . 13 )$$

Eq. 9 and Eq. 10 are substituted into Eq. 13 to obtain Eq. 14.

$$ARKXi = MM ( INVXi ) ⊕ RKXi , where 0 \leq i \leq 3 \qquad ( Eq . 14 )$$

It is assumed that the variable MM10 is the output byte of the affine transformation (i.e., the input byte of the MixColumns/InvMixColumns unit 146), as shown in Eq. 15.

$$MMI 0 = ( MM ( I 0 ) ⊕ 0 x 63 ) \qquad ( Eq . 15 )$$

In order to optimize software performance or hardware area, the binary field multiplied-by-2 operation will first perform a left shift on the multiplicand MM10. If the most significant bit of MM10 (i.e. MSB) is 0x1, then an irreducible polynomial (i.e. 0x11B) is used to get the remainder, as shown in Eq. 16.

$$0 x 2 * MMI 0 = ( MMI 0 << 0x1 ) ⊕ 0 x 11 B , where the MSB of MMI 0 = 0 x 1 \qquad ( Eq . 16 )$$

$$0 x 2 * MMI 0 = ( MMI 0 << 0x1 ) , where the MSB of MMI 0 = 0 x 0$$

As for the simplest method of the binary field multiplied-by-3 operation in Eq. 12, the result of the binary field multiplied-by-2 operation is added to MM10, as shown in Eq. 17.

$$0 x 3 * MMI 0 = ( 0 x 2 * MMI 0 ) ⊕ MMI 0 \qquad ( Eq . 17 )$$

When the attacker can insert an error value Er into the binary field multiplied-by-2 operation, as shown in Eq. 18.

$$( 0 x 2 * MMI 0 ) ⊕ E r \qquad ( Eq . 18 )$$

This will also cause an error value Er to be inserted into the result of the binary field multiplied-by-3 operation, as shown in Eq. 19.

$$( 0 x 2 * MMI 0 ) ⊕ E r ⊕ MMI 0 = ( 0 x 3 * MMI 0 ) ⊕ E r \qquad ( Eq . 19 )$$

According to Eq. 12, the above two error values Er will be accumulated to A0 and A3, thereby forming the variables A0′ and A3′ of Eq. 20.

$$A {0}^{′} = A 0 ⊕ Er \qquad ( Eq . 20 )$$

$$A {3}^{′} = A 3 ⊕ Er$$

When Eq. 14 is executed, the actual value of the information redundancy mechanism (i.e., ARKXi′) will cancel two error values Er, making the actual value equal to the estimated value (i.e., MM(INVXi)⊕ERKXi), As shown in Eq. 21.

$${ARKXi}^{′} = A {0}^{′} ⊕ A 1 ⊕ A 2 ⊕ A {3}^{′} = A 0 ⊕ E r ⊕ A 1 ⊕ A 2 ⊕ A 3 ⊕ Er = A 0 ⊕ A 1 ⊕ A 2 ⊕ A 3 = ARKXi = MM ( I NVX 0 ) ⊕ RKX 0 \qquad ( Eq . 21 )$$

As shown in Eq. 21, since the two error values Er will cancel each other after the binary field addition operation, an effective verification method is needed to facilitate to detect the error in the binary field multiplied-by-2 operation.

In the encryption procedure, the output state array SBO generated by the byte replacement transformation of the SubbBytes/InvSubBytes unit 145 is as shown in Eq. 22.

$$SBO [ 127 : 0 ] = \{ SBO 3 [ 31 : 0 ] , SBO 1 [ 31 : 0 ] , SBO 2 [ 31 : 0 ] , SBO 0 [ 31 : 0 ] \} \qquad ( Eq . 22 )$$

Since the MixColumns/InvMixColumns unit 146 performs the mix column operation in 32-bit as a unit, SBO[127:0] of Eq. 22 is represented as being divided four sets of 32 bits. Eq. 23 performs three iterations of the binary field addition operations on SBO0, SBO1, SBO2 and SBO3 to generate a simplified output state array SBOXi[7:0].

$$SBOXi [ 7 : 0 ] = ( SBOi [ 31 : 24 ] ⊕ SBOi [ 23 : 16 ] ⊕ SBOi [ 15 : 8 ] ⊕ SBOi [ 7 : 0 ] ) , where 0 \leq i \leq 3 = ( MM ( I 3 ) ⊕ 0 x 63 ) ⊕ ( MM ( I 2 ) ⊕ 0 x 63 ) ⊕ ( MM ( I 1 ) ⊕ 0 x 63 ) ⊕ ( MM ( I 0 ) ⊕ 0 x 63 ) = MM ( I 3 ) ⊕ MM ( I 2 ) ⊕ MM ( I 1 ) ⊕ MM ( I 0 ) = MM ( INVXi ) \qquad ( Eq . 23 )$$

As shown in FIG. 2, since of the SubbBytes/InvSubBytes unit 145 performing the byte replacement transformation includes the multiplication inverse unit 220 and the affine transformation unit 230, plus the affine transformation unit 230 performing the affine transformation includes a matrix multiplication operation (that is, the MM operation of Eq. 12) and a binary field addition operation (that is, performing the mutually exclusive-OR operation on the result of the MM operation and 0x63). Therefore, Eq. 23 can also be expressed by I0, I1, I2, I3, and MM operations.

Finally, through the optimization procedure of Eq. 23, we can know that the simplified output state array SBOXi[7:0] is equal to MM(INVXi). The result of Eq. 23 is put into Eq. 14 to form Eq. 24. In addition, errors occurring in the mix column operation performed by the MixColumns/InvMixColumns unit 146 and the transformation performed by the addroundkey unit 147 can be detected through Eq. 24.

$$ARKXi = MM ( INVXi ) ⊕ RKXi = SBOXi ⊕ RKXi , where 0 \leq i \leq 3 \qquad ( Eq . 24 )$$

On the other hand, in the decryption procedure, the output state array ISBO generated by the inverse byte replacement transformation of the SubbBytes/InvSubBytes unit 145 is as shown in Eq. 25.

$$ISBO [ 127 : 0 ] = \{ ISBO 3 [ 31 : 0 ] , ISBO 1 [ 31 : 0 ] , ISBO 2 [ 31 : 0 ] , ISBO 0 [ 31 : 0 ] \} \qquad ( Eq . 25 )$$

Since the MixColumns/InvMixColumns unit 146 performs inverse mix column operation in 32-bit as a unit, the ISBO[127:0] of Eq. 25 is divided into four 32-bit units. Eq. 26 performs three iterations of the binary field addition operations on ISBO0, ISBO1, ISBO2, and ISBO3 (i.e., Z0⊕Z1⊕Z2⊕Z3) to generate a simplified output state array ISBOXi[7:0].

$$ISBOXi [ 7 : 0 ] = ( ISBOi [ 31 : 24 ] ⊕ ISBOi [ 23 : 16 ] ⊕ ISBOi [ 15 : 8 ] ⊕ ISBOi [ 7 : 0 ] ) = Z 0 ⊕ Z 1 ⊕ Z 2 ⊕ Z 3 , where 0 \leq i \leq 3 \qquad ( Eq . 26 )$$

$$A 0 = ( 0 xE * Z 0 ) ⊕ ( 0 xB * Z 1 ) ) ⊕ ( 0 xD * Z 2 ) ) ⊕ ( 0 x 9 * Z 3 ) ) ⊕ R 0 ; \qquad ( Eq . 27 )$$

$$A 1 = ( 0 x 9 * Z 0 ) ⊕ ( 0 xE * Z 1 ) ) ⊕ ( 0 xB * Z 2 ) ) ⊕ ( 0 xD * Z 3 ) ) ⊕ R 1 ;$$

$$A 2 = ( 0 xD * Z 0 ) ⊕ ( 0 x 9 * Z 1 ) ) ⊕ ( 0 xE * Z 2 ) ) ⊕ ( 0 xB * Z 3 ) ) ⊕ R 2 ;$$

$$A 3 = ( 0 xB * Z 0 ) ⊕ ( 0 xD * Z 1 ) ) ⊕ ( 0 x 9 * Z 2 ) ) ⊕ ( 0 xE * Z 3 ) ) ⊕ R 3 ;$$

It is known from Eq. 11 that the result of adding up A0, A1, A2, and A3 of Eq. 27 is equal to the simplified result data ARKXi[7:0], as shown in Eq. 28. The simplified result data ARKXi will be equal to the sum of the four output bytes of the simplified output state array ISBOXi[7:0](i.e., ISBOXi=Z0⊕Z1⊕Z2⊕Z3) plus the sum of each byte of the simplified round key RKXi[7:0](i.e., RKXi=R0⊕R1⊕R2⊕R3) shown in Eq. 10.

$$ARKXi = A 0 ⊕ A 1 ⊕ A 2 ⊕ A 3 = Z 0 ⊕ Z 1 ⊕ Z 2 ⊕ Z 3 ⊕ R 0 ⊕ R 1 ⊕ R 2 ⊕ R 3 = ISBOXi [ 7 : 0 ] ⊕ RKXi ; where 0 \leq i \leq 3 \qquad ( Eq . 28 )$$

Therefore, Eq. 28 can detect errors in the inverse mix column operation performed by the MixColumns/InvMixColumns unit 146 and the transformation performed by the addroundkey unit 147.

In order to detect whether the binary field multiplied-by-2 operation, the binary field multiplied-by-4 operation, and the binary field multiplied-by-8 operation of the mix column operation/inverse mix column operation performed by the MixColumns/InvMixColumns unit 146 are correct, the binary filed multiplied-by-2 operation is shown in Eq. 29.

$$MX 2 [ 7 : 0 ] = 0 x 2 * M [ 7 : 0 ] = ( M ≪ 1 ) ⊕ ( 0 x 11 B \& \{ 9 \{ M [ 7 ] \} \} = \{ M [ 7 : 0 ] , 0 x 0 \} ⊕ \{ M [ 7 ] , 0 x 0 , 0 x 0 , 0 x 0 , M [ 7 ] , M [ 7 ] , 0 x 0 , M [ 7 ] , M [ 7 ] \} ) = \{ M [ 6 : 4 ] , ( M [ 3 ] ⊕ M [ 7 ] ) , ( M [ 2 ] ⊕ M [ 7 ] ) , M [ 1 ] , ( M [ 0 ] ⊕ M [ 7 ] ) , M [ 7 ] \} ) \qquad ( Eq . 29 )$$

It is assumed that the multiplied-by-2 array MX2 is the result of performing the binary field multiplied-by-2 operation on the multiplicand array M. For optimization, the binary field multiplied-by-2 operation will first perform a left shift on the multiplicand array M. If the most significant bit of the multiplicand array M (i.e., M[7]) is 0x1, the irreducible polynomial (i.e., 0x11B) is used to take the remainder. Therefore, the multiplier array MX2 can be simplified to a value consisting only of the bits of the multiplicand array M, as shown in Eq. 29.

Among them, {9{MX2[7]}} in Eq. 29 refers to the 8th bit (that is, the most significant bit) of the multiplied-by-2 array MX2 repeating 9 bits. In other words, {9{MX2[7]}} is equal to {MX2[7], MX2[7], MX2[7], MX2[7], MX2[7], MX2[7], MX2[7], MX2[7], MX2[7]}. For the convenience of subsequent explanation, MUL2( ) is used below to represent the binary field multiplied-by-2 operation, as shown in Eq. 30.

$$MUL 2 = \{ M [ 6 : 4 ] , ( M [ 3 ] ⊕ M [ 7 ] ) , ( M [ 2 ] ⊕ M [ 7 ] ) , M [ 1 ] , ( M [ 0 ] ⊕ M [ 7 ] ) , M [ 7 ] \} = MX 2 [ 7 : 0 ] \qquad ( Eq . 30 )$$

As shown in Eq. 30, each bit of the multiplier array MX2 can be expressed as the bits of the multiplicand array M. In other words, each bit of the multiplicand array M can also be expressed as the bits of the multiplied by two array MX2.

$$M [ 6 ] = MX 2 [ 7 ] ; \qquad ( Eq . 31 )$$

$$M [ 5 ] = MX 2 [ 6 ] ;$$

$$M [ 4 ] = MX 2 [ 5 ] ;$$

$$M [ 1 ] = MX 2 [ 2 ] ;$$

$$M [ 7 ] = MX 2 [ 0 ] ;$$

First, in Eq. 31, the corresponding relationship between the value of the multiplicand array M and the value of the multiplier array MX2 is found out, which belongs to the part of one-to-one transformation. At this time we can know that the 7th, 6th, 5th, 2nd, and 8th bits of the multiplicand array M correspond to the 8th, 7th, 6th, 3rd, and 1st bits of the multiplier array MX2 respectively.

Next, the bits of the known multiplicand array M are brought into the non-one-to-one-transformation bits of Eq. 30 to obtain the bits of the remaining unknown multiplicand array M. From Eq. 30, we know MX2[4]=(M[3]⊕M[7]). Add M[7] to both sides of the equal sign to get M[3]=(MX2[4]⊕M[7]), as shown in Eq. 32.

$$MX 2 [ 4 ] = ( M [ 3 ] ⊕ M [ 7 ] ) \\ M [ 3 ] = MX 2 [ 4 ] ⊕ M [ 7 ] = MX 2 [ 4 ] ⊕ MX 2 [ 0 ] \qquad ( Eq . 32 )$$

M[2] is shown in Eq. 33.

$$MX 2 [ 3 ] = ( M [ 2 ] ⊕ M [ 7 ] ) \\ M [ 2 ] = MX 2 [ 3 ] ⊕ M [ 7 ] = MX 2 [ 3 ] ⊕ MX 2 [ 0 ] \qquad ( Eq . 33 )$$

M[0] is as shown in Eq. 34.

$$MX 2 [ 1 ] = ( M [ 0 ] ⊕ M [ 7 ] ) \\ M [ 0 ] = MX 2 [ 1 ] ⊕ M [ 7 ] = MX 2 [ 1 ] ⊕ MX 2 [ 0 ] \qquad ( Eq . 34 )$$

DIV2( ) represents the binary field divide-by-2 operation. Eq. 35 expresses each bit of DIV2(MX2) by the bits of the multiplied-by-2 array MX2 (that is, performing the divide-by-2 operation on the multiplied-by-2 array MX2).

$$\begin{matrix}DIV 2 ( MX 2 ) = \{ MX 2 [ 0 ] , MX 2 [ 7 : 5 ] , ( MX 2 [ 0 ] ⊕ MX 2 [ 4 ] ) , \\ ( MX 2 [ 0 ] ⊕ MX 2 [ 3 ] ) , MX 2 [ 2 ] , \\ ( MX 2 [ 0 ] ⊕ MX 2 [ 1 ] ) \} \\ = M\end{matrix} \qquad ( Eq . 35 )$$

In other words, Eq. 35 can be configured to detect whether the result of the binary field multiplied-by-2 operation (i.e., the binary field multiplied-by-2 array MX2) is correct.

It is assumed that the multiplied-by-4 array MX4 is the result of performing the multiplied-by-4 operation on the binary field multiplicand array M. As shown in Eq. 36, the multiplied-by-four array MX4 is the result of the multiplied-by-two array MX2 through MUL2( ), where MUL2( ) represents the binary field multiplied-by-2 operation.

$$MX 4 = ( MX 2 ≪ 1 ) ⊕ ( 0 x 11 B \& \{ 9 \{ MX 2 [ 7 ] \} \} ) = MUL 2 ( MX 2 ) \qquad ( Eq . 36 )$$

Next, it is assumed that the multiplied-by-8 array MX8 is the result of performing the binary field multiplied-by-8 operation on the multiplicand array M. As shown in Eq. 37, the multiplied-by-8 array MX8 is the result of the four-array MX4 through MUL2( ), as shown in Eq. 37.

$$\begin{matrix}MX 8 = ( MX 4 ≪ 1 ) ⊕ ( 0 x 11 B \& \{ 9 \{ MX 4 [ 7 ] \} \} ) \\ = MUL 2 ( MX 4 )\end{matrix} \qquad ( Eq . 37 )$$

As shown in Eq. 38, the multiplied-by-8 array MX8 through DIV2( ) can obtain the value of the multiplied-by-4 array MX4.

$$DIV 2 ( MX 8 ) = MX 4 \qquad ( Eq . 38 )$$

In the same way, as shown in Eq. 39, the multiplied-by-4 array MX4 through DIV2( ) can obtain the value of the multiplied-by-2 array MX2.

$$DIV 2 ( MX 4 ) = MX 2 \qquad ( Eq . 39 )$$

In other words, whether the binary field multiplied-by-2 operation, the binary field multiplied-by-4 operation, and the binary field multiplied-by-8 operation are correct can be checked by Eq. 35, Eq. 38, and Eq. 39, as shown in Eq. 40.

$$VF 1 = ( DIV 2 ( MX 2 ) == M ) \& ( DIV 2 ( MX 4 ) == MX 2 ) \& ( DIV 2 ( MX 8 ) == MX 4 ) \qquad ( Eq . 40 )$$

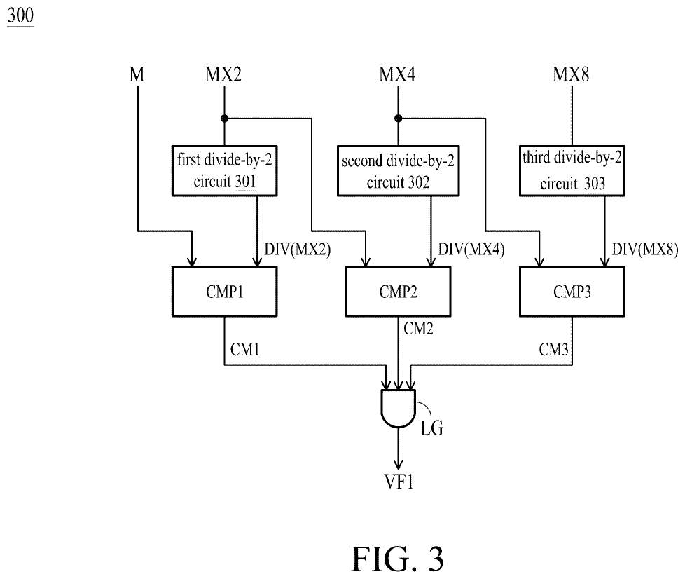

FIG. 3 is a schematic diagram showing a second verification unit in accordance with an embodiment of the present invention. According to an embodiment of the present invention, the second verification unit 300 in FIG. 3 is used to execute Eq. 40. As shown in FIG. 3, the second verification unit 300 includes a first divide-by-2 circuit 301, a second divide-by-2 circuit 302, a third divide-by-2 circuit 303, a first comparator CMP1, a second comparator CMP2, and a third comparator CMP3, and a logic gate LG.

The first divide-by-2 circuit 301 performs a divide-by-2 operation on the multiplied-by-2 array MX2 to generate a first result DIV2(MX2). The second divide-by-2 circuit 302 performs a divide-by-2 operation on the multiplied-by-4 array MX4 to generate a second result DIV2(MX4). The third divide-by-2 circuit 303 performs a divide-by-2 operation on the multiplied-by-8 array MX8 to generate a third result DIV2(MX8).

The first comparator CMP1 compares the multiplicand array M with the first result DIV2 (MX2) to generate a first comparison result CM1. When the multiplicand array M and the first result DIV2 (MX2) are equal, the first comparison result CM1 is the first logic level.

The second comparator CMP2 compares the multiplied-by-2 array MX2 and the second result DIV2(MX4) to generate a second comparison result CM2. When the multiplied-by-2 array MX2 is equal to the second result DIV2(MX4), the second comparison result CM2 is the first logic level.

The third comparator CMP3 compares the multiplied-by-4 array MX4 and the third result DIV2(MX8) to generate a third comparison result CM3. When the multiplied-by-4 array MX4 is equal to the third result DIV2(MX8), the third comparison result CM3 is the first logic level.

According to an embodiment of the present invention, when the first comparison result CM1, the second comparison result CM2, and the third comparison result CM3 are all the first logic level, the logic gate LG outputs the first verify signal VF1 at the first logic level. According to other embodiments of the present invention, when at least one of the first comparison result CM1, the second comparison result CM2, and the third comparison result CM3 is not at the first logic level, the first verification signal VF1 is not at the first logic level.

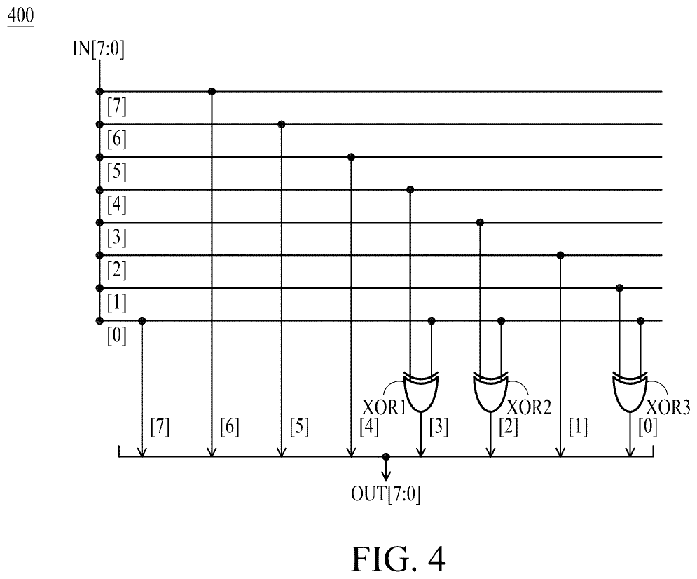

FIG. 4 is a schematic diagram showing a divide-by-2 circuit in accordance with an embodiment of the present invention. According to an embodiment of the present invention, the divide-by-2 circuit 400 in FIG. 4 corresponds to any one of the first divide-by-2 circuit 301, the second divide-by-2 circuit 302, and the third divide-by-2 circuit 303 in FIG. 3. According to an embodiment of the present invention, the divide-by-2 circuit 400 is used to perform the divide-by-2 operation shown in Eq. 35.

As shown in FIG. 4, the divide-by-2 circuit 400 is used to perform the divide-by-2 operation shown in Eq. 35 on the input array IN[7:0] to generate the output array OUT[7:0]. The divide-by-2 circuit 400 takes the first bit IN[0](i.e., the least significant bit) of the input array as the eighth bit OUT[7](i.e., the most significant bit) of the output array; the divide-by-2 circuit 400 takes the eighth bit IN[7] of the input array (i.e., the most significant bit) as the seventh bit OUT[6] of the output array; the divide-by-2 circuit 400 takes the seventh bit IN[6] of the input array as the sixth bit OUT[5] of the output array is.

The divide-by-2 circuit 400 takes the sixth bit IN[5] of the input array as the fifth bit OUT[4] of the output array; the first exclusive OR gate XOR1 of the divide-by-2 circuit 400 performs a mutually exclusive-OR operation on the fifth bit IN[4] and the first bit IN[0] of the input array to obtain the fourth bit OUT[3] of the output array; the second mutually exclusive-OR gate XOR2 of the divide-by-2 circuit 400 performs a mutually exclusive-OR operation on the fourth bit IN[3] of the input array and the first bit IN[0] of the input array to obtain the third bit OUT[2] of the output array.

The divide-by-2 circuit 400 takes the third bit IN[2] of the input array as the second bit OUT[1] of the output array; the third mutually exclusive-OR gate XOR3 of the divide-by-2 circuit 400 performs a mutually exclusive-OR operation on the second bit IN[1] of the input array and the first bit IN[0] of the input array to obtain the first bit OUT[0](i.e., the least significant bit) of the output array.

According to some embodiments of the present invention, Eq. 4 and Eq. 7 can be optimized. The first predetermined value CI[7:0] may be composed of the first value V1 and 0x0, as shown in Eq. 41.

$$CI [ 7 : 0 ] = \{ 0 x 0 , V 1 , V 1 , 0 x 0 , 0 x 0 , 0 x 0 , V 1 , V 1 \} \qquad ( Eq . 41 )$$

The second predetermined value CO[7:0] may be composed of the second value V2 and 0x0, as shown in Eq. 42, in which the second value V2 is the inverse of the first value V1.

$$CO [ 7 : 0 ] = \{ 0 x 0 , V 2 , V 2 , 0 x 0 , 0 x 0 , 0 x 0 , V 2 , V 2 \} \qquad ( Eq . 42 )$$

According to an embodiment of the present invention, when the encryption/decryption circuit 140 in FIG. 1 executes the encryption procedure, the first value V1 is 0x0 and the second value V2 is 0x1. Therefore, the first predetermined value CI[7:0] is 0x0, and the second predetermined value CO[7:0] is 0x63. According to another embodiment of the present invention, when the encryption/decryption circuit 140 in FIG. 1 executes the decryption procedure, the first value V1 is 0x1 and the second value V2 is x0. Therefore, the first predetermined value CI[7:0] is 0x63, and the second predetermined value CO[7:0] is x0.

Next, as shown in FIG. 1, since the input state array SBI and the input state array ISBI both can be the input of the SubbBytes/InvSubBytes unit 145, and the output state array SBO and the output state array ISBO both can be the output of the SubbBytes/InvSubBytes unit 145, below the input of the SubbBytes/InvSubBytes unit 145 is defined as the input state array SI and the output of the SubbBytes/InvSubBytes unit 145 is defined as the output state array SO. In other words, when the encryption/decryption circuit 140 performs the encryption procedure, SI is SBI and SO is SBO. When the encryption/decryption circuit 140 performs the decryption procedure, SI is ISBI and SO is ISBO.

As shown in Eq. 43, when the second value V2 is 0x1, the first selection array SEL1 is the input state array SI; when the second value V2 is 0x0, the first selection array SEL1 is the output state array SO. In other words, when the encryption/decryption circuit 140 performs the encryption procedure, the second value V2 is 0x1, and the first selection array SEL1 is the input state array SI; when the encryption/decryption circuit 140 performs the decryption procedure, the second value V2 is 0x0, and the first selection array SEL1 is the output state array SO.

$$SEL 1 = V 2 ? SI : SO \qquad ( Eq . 43 )$$

As shown in Eq. 44, when the second value V2 is 0x1, the second selection array SEL2 is the output state array SO; when the second value V2 is 0x0, the second selection array SEL2 is the input state array SI. In other words, when the encryption/decryption circuit 140 performs the encryption procedure, the second value V2 is 0x1, and the second selection array SEL2 is the output state array SO; when the encryption/decryption circuit 140 performs the decryption procedure, the second value V2 is 0x0, the second selection array SEL2 is the input status array SI.

$$SEL 2 = V 2 ? SO : SI \qquad ( Eq . 44 )$$

According to Eq. 41 to Eq. 44, Eq. 4 and Eq. 7 can be optimized as Eq. 45.

$$VF 2 = ( SI [ 7 : 0 ] == CI ) ? ( SO [ 7 : 0 ] == C 0 ) : ( SEL 1 * {AT}^{- 1} ( SEL 2 ) ) == 0 x 1 ) \qquad ( Eq . 45 )$$

Comparing Eq. 45 with Eq. 4 and Eq. 7, the encryption procedure and the decryption procedure can share the same binary field multiplier and the InvAffine transformation unit, thereby saving one binary field multiplier and one InvAffine transformation unit.

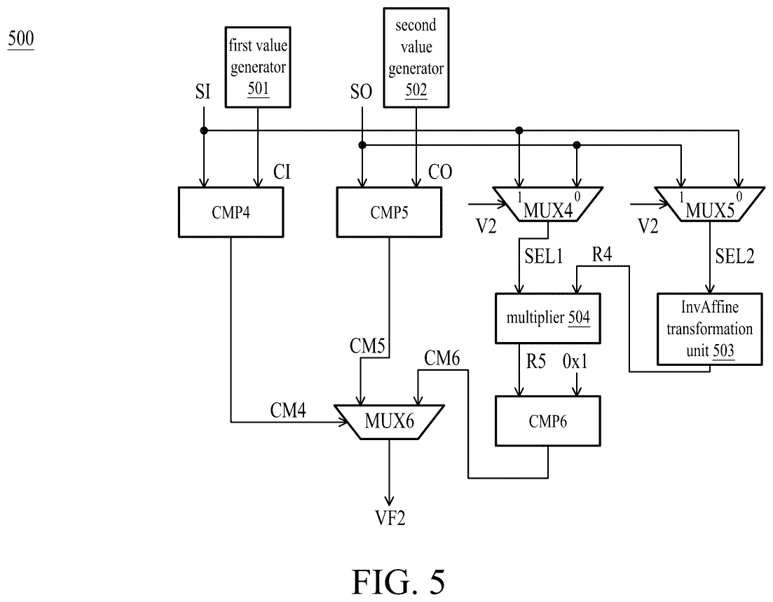

FIG. 5 is a schematic diagram showing a first verification unit in accordance with an embodiment of the present invention. According to an embodiment of the present invention, the first verification unit 500 in FIG. 5 is configured to perform Eq. 45.

As shown in FIG. 5, the first verification unit 500 includes a first value generator 501, a second value generator 502, a fourth comparator CMP4, a fifth comparator CMP5, a fifth multiplexer MUX4, a six multiplexers MUX5, an InvAffine transformation unit 503, a multiplier 504, a sixth comparator CMP6, and a seventh multiplexer MUX6.

The first value generator 501 is configured to execute Eq. 41 to generate a first predetermined value CI, in which the bits from the most significant bit to the least significant bit of the first predetermined value CI are 0x0, the first value V1, the first value V1, 0x0, 0x0, 0x0, a first value V1, and a first value V1 in sequence. The second value generator 502 is configured to execute Eq. 42 to generate a second predetermined value CO, in which the bits from the most significant bit to the least significant bit of the second predetermined value CO are 0x0, the second value V2, the second value V2, 0x0, 0x0, 0x0, the second value V2, and the second value V2 in sequence.

The fourth comparator CMP4 determines whether the input state array SI and the first predetermined value CI are equal to generate a fourth comparison result CM4. When the input state array SI is equal to the first predetermined value CI, the fourth comparison result CM4 is at the first logic level. The fifth comparator CMP5 compares the output state array SO with the second predetermined value CO to generate a fifth comparison result CM5. When the output state array SO is equal to the second predetermined value CO, the fifth comparison result CM5 is at the first logic level.

The fifth multiplexer MUX4 performs Eq. 43 and selects the input state array SI or the output state array SO as the first selection array SEL1 based on the second value V2. According to an embodiment of the present invention, when the encryption/decryption circuit 140 in FIG. 1 executes the encryption procedure, the first selection array SEL1 is the input status array SI. According to another embodiment of the present invention, when the encryption/decryption circuit 140 in FIG. 1 executes the decryption procedure, the first selection array SEL1 is the output state array SO.

The sixth multiplexer MUX5 executes Eq. 44 and selects the input state array SI or the output state array SO as the second selection array SEL2 based on the second value V2. According to an embodiment of the present invention, when the encryption/decryption circuit 140 in FIG. 1 executes the encryption procedure, the second selection array SEL2 is the output state array SO. According to another embodiment of the present invention, when the encryption/decryption circuit 140 in FIG. 1 executes the decryption procedure, the second selection array SEL2 is the input status array SI.

The InvAffine transformation unit 503 performs the inverse affine transformation (i.e., AT¹) on the second selection array SEL2 to generate a fourth result R4. The multiplier 504 multiplies the first selection array SEL1 by the fourth result R4 to generate a fifth result R5. The sixth comparator CMP6 compares the fifth result R5 and 0x1 to generate a sixth comparison result CM6. When the fifth result R5 is equal to 0x1, the sixth comparison result CM6 is the first logic level.

Based on the fourth comparison result CM4, the sixth multiplexer MUX6 outputs the fifth comparison result CM5 or the sixth comparison result CM6 as the second verification signal VF2. According to an embodiment of the present invention, when the second verification signal VF2 is at the first logic level, it indicates that the byte replacement transformation or inverse byte replacement transformation performed by the SubbBytes/InvSubBytes unit 145 in FIG. 1 is correct. According to another embodiment of the present invention, when the second verification signal VF2 is not at the first logic level, it indicates that the byte replacement transformation or the inverse byte replacement transformation performed by the SubbBytes/InvSubBytes unit 145 in FIG. 1 is incorrect.

Eq. 24 can detect errors in the mix column operation performed by the MixColumns/InvMixColumns unit 146 and the transformation performed by the addroundkey unit 147, and Eq. 28 can detect errors that occur in the mix column/inverse mix column operation performed by the MixColumns/InvMixColumns unit 146 and the transformation performed by the addroundkey unit 147, in which Eq. 24 and Eq. 28 can be optimized into Eq. 46.

$$\begin{matrix}VF 3 = ( ARKXi == ( ISBOXi [ 7 : 0 ] ⊕ RKXi ) ) = \\ ( ARKXi == ( SBOXi [ 7 : 0 ] ⊕ RKXi ) ) \\ = ( ARKXi == ( SOXi [ 7 : 0 ] ⊕ RKXi ) ) , where 0 \leq i \leq 3\end{matrix} \qquad ( Eq . 46 )$$

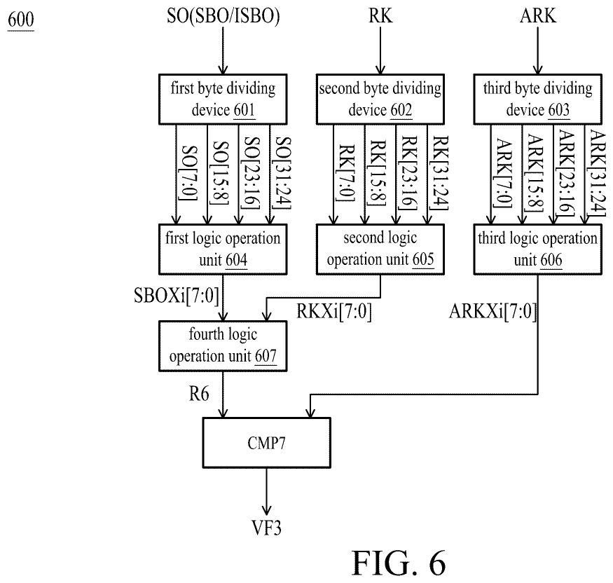

FIG. 6 is a schematic diagram showing a third verification unit in accordance with an embodiment of the present invention. According to an embodiment of the present invention, the third verification unit 600 in FIG. 6 is used to execute the Eq. 46 to detect whether the transformations performed by the MixColumns/InvMixColumns unit 146 and the addroundkey unit 147 in FIG. 1 are correct.

As shown in FIG. 6, the third verification unit 600 includes a first byte dividing device 601, a second byte-dividing device 602, a third byte dividing device 603, a first logic operation unit 604, a second logic operation unit 605, a third logic operation unit 606, a fourth logic operation unit 607, and a seventh comparator CMP7.

The first byte dividing device 601 divides the output state array SO (including SBO and ISBO) into bytes to generate divided output state arrays SO[7:0], SO[15:8], SO [23:16], SO[31:24]. The second byte dividing device 602 divides the round key RK into bytes to generate divided round keys RK[7:0], RK[15:8], RK[23:16], RK[31:24]. The third byte dividing device 603 divides the result data ARK into bytes to generate divided result data ARK[7:0], ARK[15:8], ARK[23:16], ARK[31:24].

The first logical operation unit 604 performs the mutually exclusive-OR operation on the divided output state arrays SO[7:0], SO[15:8], SO[23:16], SO[31:24] to generate simplified output status array SBOXi[7:0]. The second logic operation unit 605 performs the mutually exclusive-OR operation on the divided round keys RK[7:0], RK[15:8], RK[23:16], and RK[31:24] to generate a simplified round key RKXi[7:0]. The third logic operation unit 606 performs a mutually exclusive-OR operation on the divided result data ARK[7:0], ARK[15:8], ARK[23:16], and ARK[31:24] to generate simplified result data ARKXi[7:0].

The fourth logic operation unit 607 performs the mutually exclusive-OR operation on the simplified output state array SBOXi[7:0] and the simplified round key RKXi[7:0] to generate a sixth result R6. The seventh comparator CMP7 compares the sixth result R6 and the simplified result data ARKXi[7:0] to generate the third verification signal VF3.

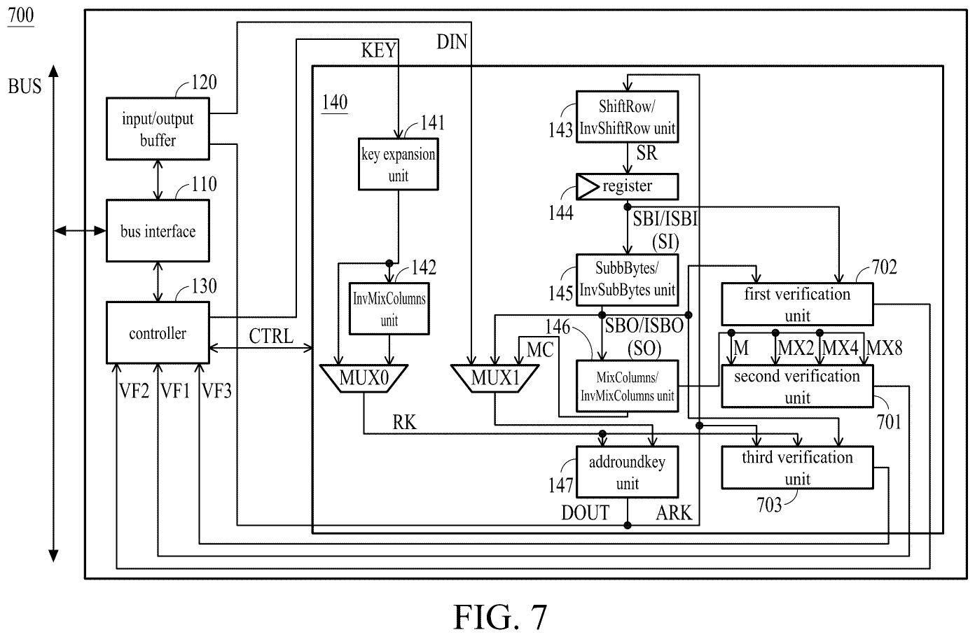

FIG. 7 is a block diagram showing an encryption/decryption device in accordance with another embodiment of the present invention. Comparing the encryption/decryption device 700 in FIG. 7 with the encryption/decryption device 100 in FIG. 1, the encryption/decryption device 700 further includes a second verification unit 701, a first verification unit 702, and a third verification unit 703.

According to an embodiment of the present invention, the second verification unit 701 corresponds to the second verification unit 300 in FIG. 3 and is used to execute Eq. 40. When the first verification signal VF1 is at the first logic level, the controller 130 determines that the binary field multiplied-by-2 operation, the multiplied-by-4 operation, and multiplied-by-8 operation performed by the MixColumns/InvMixColumns unit 146 are correct.

According to an embodiment of the present invention, the first verification unit 702 corresponds to the first verification unit 500 in FIG. 5 and is used to execute Eq. 45. When the second verification signal VF2 is at the first logic level, the controller 130 determines whether the byte replacement transformation or the inverse byte replacement transformation performed by the SubbBytes/InvSubBytes unit 145 is correct.

According to an embodiment of the present invention, the third verification unit 703 corresponds to the third verification unit 600 in FIG. 6, which is configured to execute Eq. 46. When the third verification signal VF3 is at the first logic level, the controller 130 determines that the mix column operation or the inverse mix column operation performed by the MixColumns/InvMixColumns unit 146 and the transformation performed by the addroundkey unit 147 are correct.

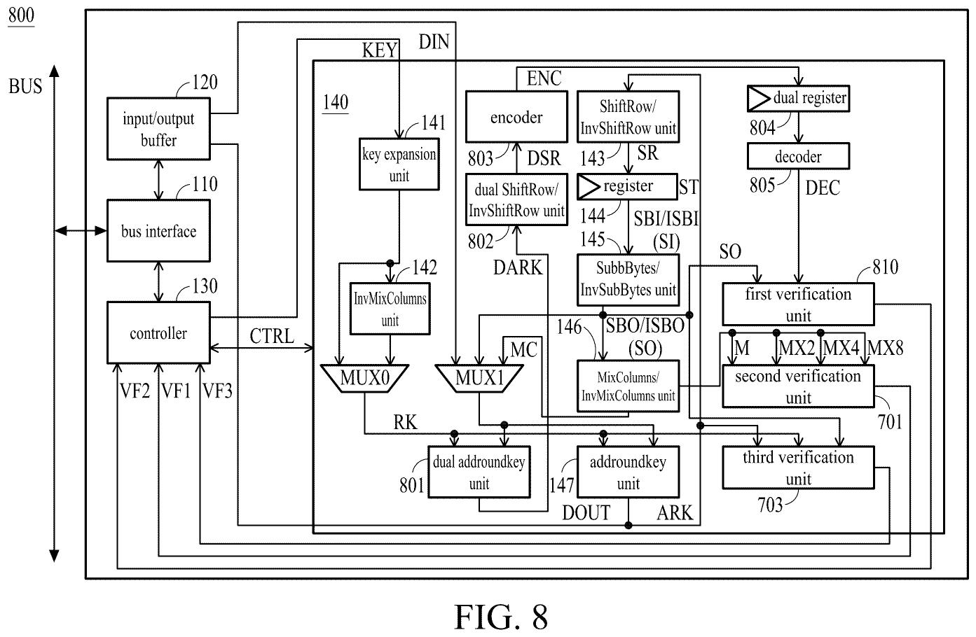

FIG. 8 is a block diagram showing an encryption/decryption device in accordance with yet another embodiment of the present invention. Compared with the encryption/decryption device 700, the encryption/decryption device 800 further includes a dual addroundkey unit 801, a dual ShiftRow/InvShiftRow unit 802, an encoder 803, a dual register 804, and a decoder 805. The encryption/decryption device 800 is configured to determine whether the transfer between the register 144 and each conversion is correct.

The circuit structure of the dual addroundkey unit 801 is the same as that of the addroundkey unit 147, and is configured to perform the transformation of the addroundkey unit 147 again to generate the dual result data DARK. The circuit structure of the dual ShiftRow/InvShiftRow unit 802 and that of the ShiftRow/InvShiftRow unit 143 are the same. Thus, the dual ShiftRow/InvShiftRow unit 802 shifts each row of the dual result data DARK in a circular manner to generate dual shift data DSR. According to some embodiments of the present invention, the ShiftRow/InvShiftRow operation performed by the dual ShiftRow/InvShiftRow unit 802 is the same as the ShiftRow/InvShiftRow operation performed by the ShiftRow/InvShiftRow unit 143.

The encoder 803 performs an encoding operation on the dual shift data DSR to generate encoded data ENC. The dual register 804 is configured to store the encoded data ENC, and the register 144 stores the shift data SR as the status data ST. The decoder 805 performs a decoding operation on the encoded data ENC stored in the dual register 804 to generate decoded data DEC. According to some embodiments of the present invention, the encoding operation performed by the encoder 803 is the inverse function of the decoding operation performed by the decoder 805. According to some embodiments of the present invention, the encoding operation performed by the encoder 803 may be any known or unknown encoding method.

According to some embodiments of the present invention, when the operations of the ShiftRow/InvShiftRow unit 143, the register 144, and the addroundkey unit 147 are all correct, the decoded data DEC should be equal to the input status array SI.

Compared to the first verification unit 702 in FIG. 7 which verifies whether the byte replacement transformation or the inverse byte replacement transformation performed by the SubbBytes/InvSubBytes unit 145 is correct based on the input state array SI and the output state array SO, the first verification unit 810 in FIG. 8 verifies whether the byte replacement transformation or the inverse byte replacement transformation performed by the SubbBytes/InvSubBytes unit 145 is correct based on the decoded data DEC and the output status array SO.

According to some embodiments of the present invention, whether the transformation of the addroundkey unit 147 is correct can be determined by comparing whether the dual result data DARK and the result data ARK are consistent or whether the dual shift data DSR and the shift data SR are consistent. Whether the shift operation performed by the ShiftRow/InvShiftRow unit 143 is correct can be also determined by comparing whether the dual result data DARK and the result data ARK are consistent or whether the dual shift data DSR and the shift data SR are consistent. According to some embodiments of the present invention, whether the status data ST stored in the register 144 is correct can be determined by comparing the decoded data DEC to the status data ST stored in the register 144.

In addition, as shown in Eq. 40, the second verification unit 701 performs a division operation on the multiplied-by-2 array MX2 to generate a multiplied-by-2-and-divided-by-2 array MX2D2, and determines whether the multiplied-by-2 array MX2D2 is equal to the binary field multiplicand array M. In other words, when the transformations of the ShiftRow/InvShiftRow unit 143, the register 144, the SubbBytes/InvSubBytes unit 145, the second multiplexer MUX1, and the addroundkey unit 147 and the binary field multiplication operation of the MixColumns/InvMixColumns unit 146 are all correct, the multiplied-by-2-and-divided-by-2 array MX2D2 is equal to the multiplicand array M, where the multiplicand array M is equal to the output state array SO. In other words, the multiplied-by-2-and-divided-by-2 array MX2D2 can be configured to replace the output state array SO.

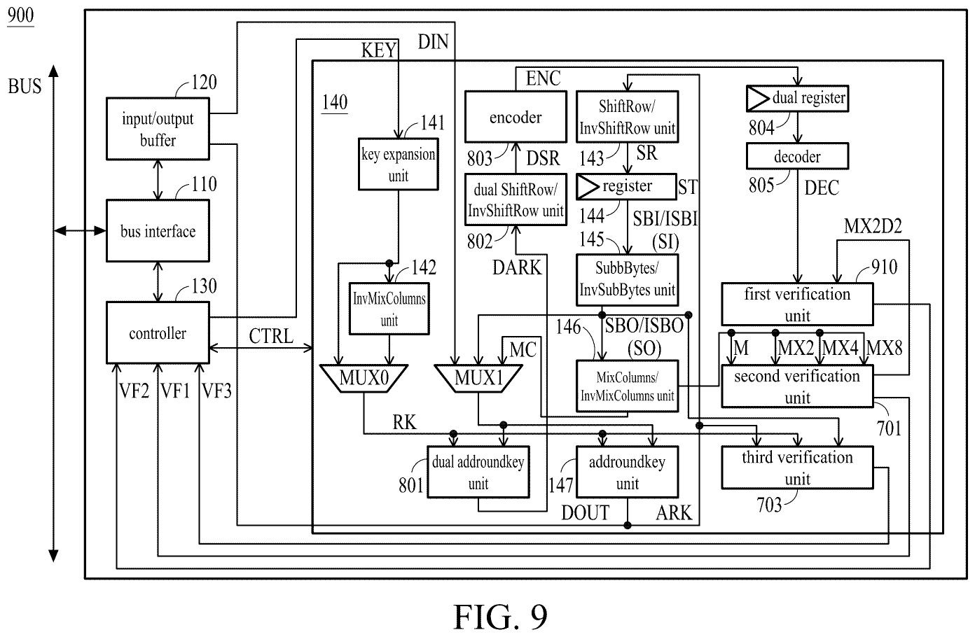

FIG. 9 is a block diagram showing an encryption/decryption device in accordance with yet another embodiment of the present invention. Compared to the encryption/decryption device 800 in FIG. 8, the first verification unit 910 of the encryption/decryption device 900 verifies whether the byte replacement transformation or the inverse byte replacement transformation performed by the SubbBytes/InvSubBytes unit 145 is correct based on the decoded data DEC and the multiplied-by-2-and-divided-by-2 array MX2D2 generated by the second verification unit 701.

Since the decoded data DEC is generated by the input state array SI through another set of hardware, and the multiplied-by-2-and-divided-by-2 array MX2D2 is generated by performing the multiplied-by-2 operation and the divided-by-2 operation on the output state array SO, the second verification signal VF2 can be not only configured to determine whether the byte replacement transformation or the inverse byte replacement transformation performed by the SubbBytes/InvSubBytes unit 145 is correct, but also configured to determine whether the transmission among the ShiftRow/InvShiftRow unit 143, the SubbBytes/InvSubBytes unit 145, the MixColumns/InvMixColumns unit 146, and the addroundkey unit 147 is correct, and whether the status data ST stored in the register 144 is correct can be also determined at the meanwhile.

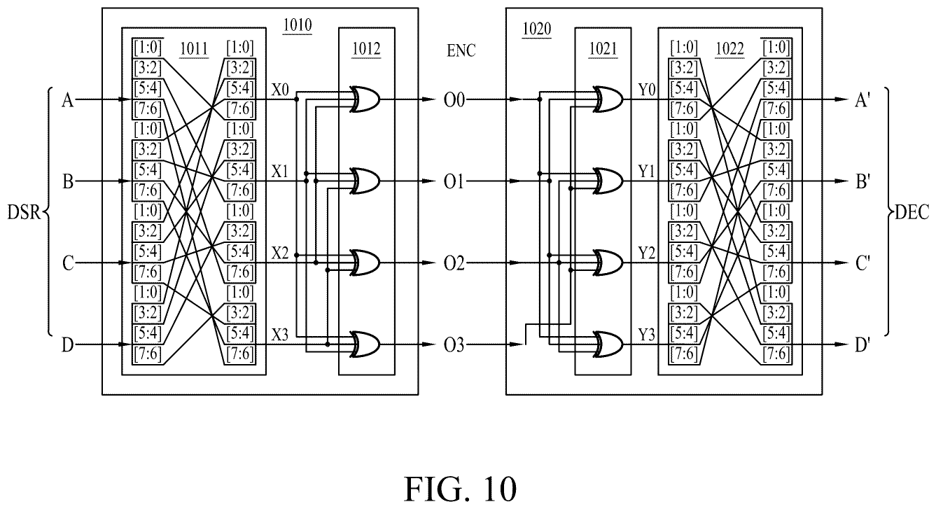

FIG. 10 is a schematic diagram showing an encoding operation and a decoding operation in accordance with an embodiment of the present invention. As shown in FIG. 10, the encoder 1010 includes a first transposition unit 1011, a first binary field addition unit 1012, and the decoder 1020 includes a second binary field addition unit 1021 and a second transposition unit 1022, where the encoder 1010 and decoder 1020 correspond to the encoder 803 and decoder 805 in FIGS. 8 and 9 respectively.

As shown in FIG. 10, when the encoder 1010 receives the dual shift data DSR, the dual shift data DSR is divided into first encoded data A, second encoded data B, third encoded data C and fourth Coding data D. The first transposition unit 1011 performs a transposition operation on the first coded data A, the second coded data B, the third coded data C, and the fourth coded data D to generate the first transposed data X0, the second transposed data X1, the third transposition data X2, and the fourth transposition data X3. The first binary field addition unit 1012 includes a plurality of mutually exclusive-OR gates for performing the mutually exclusive-OR operation on any three of the first transposed data X0, the second transposed data X1, the third transposed data X2, and the fourth transposed data X3 to generate the encoded data ENC, where the encoded data ENC includes the first encoded data O0, the second encoded data O1, the third encoded data O2, and the fourth encoded data O3.

When the decoder 1020 receives the encoded data ENC, the second binary field addition unit 1021 performs the mutually exclusive-OR operation on any three of the first encoded data O0, the second encoded data O1, the third encoded data O2, and the fourth encoded data O3 to generate the first mutually exclusive-OR data Y0, the second mutually exclusive-OR data Y1, the third mutually exclusive-OR data Y2, and the fourth mutually exclusive-OR data Y3. The second transposition unit 1022 performs an inverse transposition operation on the first mutually exclusive-OR data Y0, the second mutually exclusive-OR data Y1, the third mutually exclusive-OR data Y2, and the fourth mutually exclusive-OR data Y3 to generate the first decoded data A′, second decoded data B′, third decoded data C′, and fourth decoded data D′, where the first decoded data A′, second decoded data B′, third decoded data C′, and fourth decoded data D′ are combined to form the decoded data DEC. According to some embodiments of the present invention, the transposition operation performed by the first transposition unit 1011 and the inverse transposition operation performed by the second transposition unit 1022 are inverse functions of each other.

In order to enhance the protection of AES Redundancy-based Fault Attacks Countermeasure, the encoder 1010 and the decoder 1020 in FIG. 10 propose a binary field addition coding mechanism for fault space transformation. The fault space transformation method mainly implements different encoding methods for the encryption/decryption process in the normal run and redundant run of the redundant mechanism. Even if the attacker can insert the same fault at the corresponding time point into the encryption/decryption process in the normal run and the redundant run, two runs will produce very different wrong encryption or decryption states due to different encoding methods, resulting in the fault space transformation method being able to significantly reduce the probability of fault collision.

In order to reduce costs, the normal run fault space transformation method generally does not utilize any coding. Under the constraints of the minimum security requirements, the redundant run of the encryption/decryption device 800 in FIG. 8 and the encryption/decryption device 900 in FIG. 9 can use the encoding operation and decoding operation of binary field addition, which can greatly reduce the area and latency.

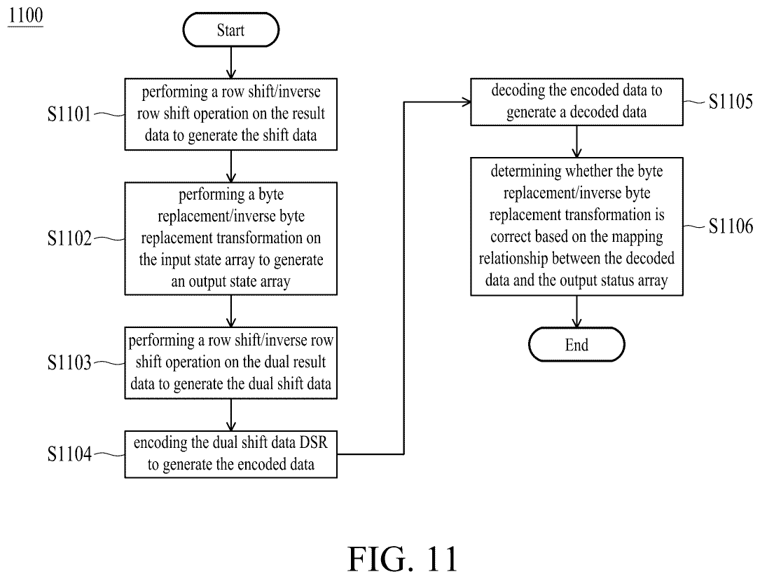

FIG. 11 is a flow chart showing an encryption/decryption method in accordance with an embodiment of the present invention. The following description of the encryption/decryption method 1100 in FIG. 11 will be combined with the encryption/decryption device 800 in FIG. 8 to facilitate detailed explanation.

First, the ShiftRow/InvShiftRow unit 143 is configured to perform a row shift/inverse row shift operation on the result data ARK to generate the shift data SR (Step S1101), where the shift data SR is stored in the register 144 as the input status array SI. Next, the SubbBytes/InvSubBytes unit 145 is configured to perform a byte replacement/inverse byte replacement transformation on the input state array SI to generate an output state array SO (Step S1102).

The dual ShiftRow/InvShiftRow unit 802 is utilized to perform a row shift/inverse row shift operation on the dual result data DARK to generate the dual shift data DSR (which can also be called the dual input state array) (Step S1103). The dual shift data DSR (also called the dual input state array) is encoded to generate the encoded data ENC (Step S1104). The encoded data ENC is decoded to generate a decoded data DEC (Step S1105).

Finally, based on the mapping relationship between the decoded data DEC and the output status array SO, whether the byte replacement/inverse byte replacement transformation performed by the SubbBytes/InvSubBytes unit 145 is correct is determined (Step S1106). According to some embodiments of the present invention, in Step S1106, the input state array SI in Eq. 43 to Eq. 45 are replaced with the decoded data DEC to generate the second verification signal VF2 so as to determine whether the byte replacement/inverse byte replacement transformation performed by the SubbBytes/InvSubBytes unit 145 is correct.

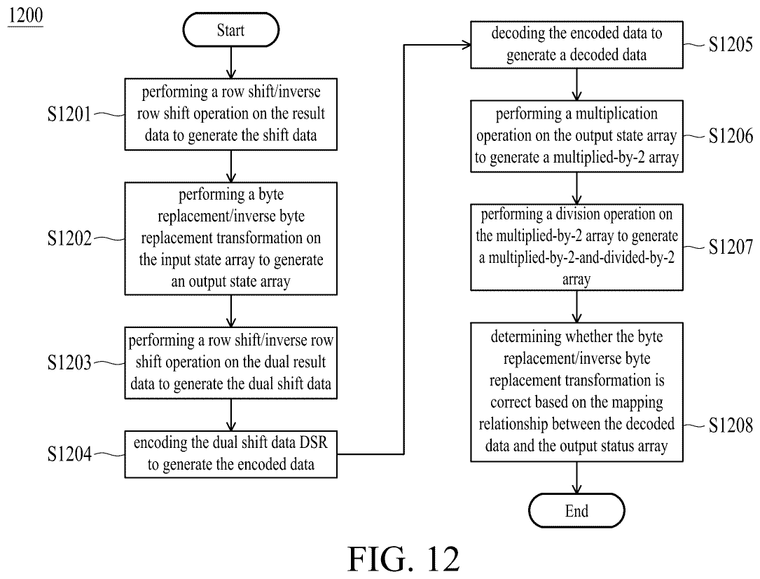

FIG. 12 is a flow chart showing an encryption/decryption method in accordance with an embodiment of the present invention. The following description of the encryption/decryption method 1200 in FIG. 12 will be combined with the encryption/decryption device 900 in FIG. 9 for detailed explanation. Compared with the encryption/decryption method 1100 in FIG. 11, Steps S1201 to S1205 of the encryption/decryption method 1200 are the same as Steps S1101 to S1105 of the encryption/decryption method 1100, which will not be repeated herein.

In Step S1206, the MixColumns/InvMixColumns unit 146 is configured to perform a multiplication operation on the output state array SO to generate a multiplied-by-2 array MX2. Next, the second verification unit 701 is configured to perform a division operation on the multiplied-by-2 array MX2 to generate a multiplied-by-2-and-divided-by-2 array MX2D2 (Step S1207). Finally, based on the mapping relationship between the decoded data DEC and the multiplied-by-2-and-divided-by-2 array MX2D2, it is determined whether the byte replacement/inverse byte replacement transformation performed by the SubbBytes/InvSubBytes unit 145 is correct (Step S1208).

According to some embodiments of the present invention, in Step S1208, the input state array SI in Eq. 43 to Eq. 45 is replaced with the decoded data DEC and the output state array SO is replaced with the multiplied-by-2-and-divided-by-2 array MX2D2 to generate the second verification signal VF2 so as to determine whether the byte replacement/inverse byte replacement transformation performed by the SubbBytes/InvSubBytes unit 145 is correct.

The present invention proposes an encryption/decryption device having a verification mechanism, which is suitable for any implementation of byte replacement transformation. Although there are many ways to implement byte replacement transformation or inverse byte replacement transformation, the verification mechanism of the encryption/decryption device of the present invention can detect whether an error has occurred in the operation when the input value of the multiplicative inverse element (Multiplicative Inverse) is 0x0, and detect whether an error has occurred in the binary field multiplication operation in the mixed column operation and the inverse mix column operation. In addition, the verification mechanism proposed by the present invention can also protect the encryption procedure and the decryption procedure to ensure the security of the encrypted/decrypted data. Furthermore, the verification mechanism proposed by the present invention can also determine whether an error has occurred during the data transmission process, thereby improving the security during the encryption and decryption processes.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An encryption/decryption device, comprising:
a ShiftRow/InvShiftRow unit, performing a row shift/inverse row shift operation on result data to generate an input state array;
a SubbBytes/InvSubBytes unit, performing a transformation on the input state array to generate an output state array;
a dual ShiftRow/InvShiftRow unit, performing the row shift/inverse row shift operation on dual result data to generate a dual input state array;
an encoder, encoding the dual input state array to generate encoded data;
a decoder, decoding the encoded data to generate decoded data;
a first verification unit, verifying a mapping relationship of the decoded data and the output state array to generate a first verification signal; and
a controller, determining whether the transformation performed by the SubbBytes/InvSubBytes unit is correct based on the first verification signal.

2. The encryption/decryption device as claimed in claim 1, further comprising:
a MixColumns/InvMixColumns unit, performing a mix column operation/inverse mix column operation on the output state array to generate a mix-column/inverse mix-column array, wherein the mix column/inverse mix column operation comprises a binary field multiplication operation; and
an addroundkey unit, performing a binary field addition operation on the mix-column/inverse mix-column array and a round key to generate the result data.

3. The encryption/decryption device as claimed in claim 2, wherein the MixColumns/InvMixColumns unit performs a multiplied-by-2 operation on the output state array to generate a multiplied-by-2 array;
wherein the encryption/decryption device further comprises:
a second verification unit, performing a divided-by-2 operation on the multiplied-by-2 array to generate a multiplied-by-2-and-divided-by-2 array and determining whether the output state array and the multiplied-by-2-and-divided-by-2 array conform to a mapping relationship to generate a second verification signal;
wherein the controller determines whether the binary field multiplication performed by the MixColumns/InvMixColumns unit is correct based on the second verification signal;
wherein when the binary field multiplication operation and the divided-by-2 operation are correct, the multiplied-by-2-and-divided-by-2 array is equal to the output state array;
wherein the first verification unit outputs the multiplied-by-2-and-divided-by-2 array as the output state array, so that the first verification unit verifies the mapping relationship of the decoded data and the multiplied-by-2-and-divided-by-2 array to generate the first verification signal.

4. The encryption/decryption device as claimed in claim 3, wherein when the encryption/decryption device executes an encryption procedure, the first verification unit determines whether the decoded data is equal to a first predetermined value;
wherein when the decoded data is equal to the first predetermined value, the first verification unit determines whether the multiplied-by-2-and-divided-by-2 array is equal to a second predetermined value;
wherein when the decoded data is equal to the first predetermined value and the multiplied-by-2-and-divided-by-2 array is equal to the second predetermined value, the first verification unit determines that the transformation is correct;
wherein when the decoded data is equal to the first predetermined value and the multiplied-by-2-and-divided-by-2 array is not equal to the second predetermined value, the first verification unit determines that the transformation is incorrect;
wherein when the encryption/decryption device performs the encryption procedure and during the transformation, the SubbBytes/InvSubBytes unit performs an affine transformation on the input state array to generate the output state array;
wherein when the decoded data is not equal to the first predetermined value, the first verification unit performs an inverse affine transformation on the multiplied-by-2-and-divided-by-2 array to generate a first result;
wherein the first verification unit further multiplies the decoded array by the first result to generate a second result;
wherein the first verification unit determines whether the second result is equal to 0x1;
wherein when the second result is equal to 0x1, the first verification unit determines that the transformation is correct;
wherein when the second result is not equal to 0x1, the first verification unit determines that the transformation is incorrect.

5. The encryption/decryption device as claimed in claim 4, wherein when the encryption/decryption device performs a decryption procedure, the first verification unit determines whether the decoded data is equal to the second predetermined value;
wherein when the decoded data is equal to the second predetermined value, the first verification unit determines whether the multiplied-by-2-and-divided-by-2 array is equal to the first predetermined value;
wherein when the decoded data is equal to the second predetermined value and the multiplied-by-2-and-divided-by-2 array is equal to the first predetermined value, the first verification unit determines that the transformation is correct;
wherein when the decoded data is equal to the second predetermined value and the multiplied-by-2-and-divided-by-2 array is not equal to the first predetermined value, the first verification unit determines that the transformation is incorrect;
wherein when the encryption/decryption device performs the decryption procedure and during the transformation, the SubBytes/InvSubBytes unit performs an inverse affine transformation on the input state array to generate the output state array;
wherein when the input state array is not equal to the second predetermined value, the first verification unit performs the inverse affine transformation on the decoded data to generate a first result;
wherein the first verification unit further multiplies the multiplied-by-2-and-divided-by-2 array by the first result to generate a second result;
wherein the first verification unit further determines whether the second result is equal to 0x1;
wherein when the second result is equal to 0x1, the first verification unit determines that the transformation is correct;
wherein when the second result is not equal to 0x1, the first verification unit determines that the transformation is incorrect.

6. The encryption/decryption device as claimed in claim 1, wherein the first verification unit comprises:
a first value generator, configured to generate a first predetermined value, wherein a most significant bit to a least significant bit of the first predetermined value are 0x0, a first value, the first value, 0x0, 0x0, 0x0, the first value, and the first value in sequence;
a second value generator, configured to generate a second predetermined value, wherein a most significant bit to a least significant bit of the second predetermined value are 0x0, a second value, the second value, 0x0, 0x0, 0x0, the second value, and the second value in sequence;
a first comparator, comparing the decoded data and the first predetermined value to generate a first result, wherein when the decoded data is equal to the first predetermined value, the first result is equal to a first logic level;
a second comparator, comparing the output state array and the second predetermined value to generate a second result, wherein when the output state array is equal to the second predetermined value, the second result is at the first logic level;
a first multiplexer, selecting the decoded data or the output state array as a first selected array;
a second multiplexer, selecting the decoded data or the output state array as a second selected array;
an InvAffine transformation unit, performing an inverse affine transformation on the second selected array to generate a third result;
a multiplier, multiplying the first selected array by the third result to generate a fourth result;
a third comparator, comparing the fourth result and 0x1 to generate a fifth result, wherein when the fourth result is equal to 0x1, the fifth result is at the first logic level; and
a third multiplexer, outputting the second result or the fifth result as the first verification signal based on the first result;
wherein when the first verification signal is at the first logic level, it indicates that the transformation is correct.

7. The encryption/decryption device as claimed in claim 6, wherein when the encryption/decryption device performs an encryption procedure, the first selected array is the decoded data;
wherein when the encryption/decryption device performs a decryption procedure, the first selected array is the output state array;
wherein when the encryption/decryption device performs the encryption procedure, the second selected array is the output state array;
wherein when the encryption/decryption device performs the decryption procedure, the second selected array is the decoded data;
wherein the second value is an inverse of the first value.

8. The encryption/decryption device as claimed in claim 3, wherein when the MixColumns/InvMixColumns unit performs the binary field multiplication operation on the multiplicand array to multiply the multiplicand array by 2, the multiplicand array is left-shifted in the amount of one bit to generate a left-shifted array;
wherein a most significant bit of the multiplicand array is duplicated with a first bit number to generate a first value, wherein a bit number of the multiplicand array is equal to the first bit number minus 1;
wherein an AND operation is performed on a first predetermined value and the first value to generate a second value;
wherein a mutually exclusive-OR operation is performed on the left-shifted array and the second value to generate a multiplied-by-2 array.

9. The encryption/decryption device as claimed in claim 8, wherein when the first bit number is 8, each bit of the multiplied-by-2 array and each bit of the multiplicand array have the mapping relationship;
wherein the mapping relationship comprises:
an eighth bit of the multiplied-by-2 array (i.e., the most significant bit) is equal to a seventh bit of the multiplicand array;
a seventh bit of the multiplied-by-2 array is equal to a sixth bit of the multiplicand array;
a sixth bit of the multiplied-by-2 array is equal to a fifth bit of the multiplicand array;
a fifth bit of the multiplied-by-2 array is equal to a result of the mutually exclusive-OR operation performed on a fourth bit of the multiplicand array and the eighth bit (i.e., the most significant bit) of the multiplicand array;
a fourth bit of the multiplied-by-2 array is equal to a result of the mutually exclusive-OR operation performed on a third bit of the multiplicand array and the eighth bit (i.e., the most significant bit) of the multiplicand array;
a third bit of the multiplied-by-2 array is equal to a second bit of the multiplicand array;
a second bit of the multiplied-by-2 array is equal to a result of the mutually exclusive-OR operation performed on a first bit of the multiplicand array and the eighth bit (i.e., the most significant bit) of the multiplicand array;
a first bit (i.e., the least significant bit) of the multiplied-by-2 array is equal to the eighth bit (i.e., the most significant bit) of the multiplicand array.

10. The encryption/decryption device as claimed in claim 9, wherein the second verification unit determines whether the multiplied-by-2 operation is correct based on whether each bit of the multiplicand array and each bit of the multiplied-by-2 array conform to the mapping relationship.

11. The encryption/decryption device as claimed in claim 10, wherein the MixColumns/InvMixColumns unit further performs a multiplied-by-4 operation on the multiplicand array to generate the multiplied-by-4 array;
wherein the multiplied-by-4 operation is equivalent to two iterations of the multiplied-by-2 operation;
wherein the second verification unit determines whether the multiplied-by-4 operation is correct based on whether the multiplied-by-2 array and the multiplied-by-4 array conform to the mapping relationship.

12. The encryption/decryption device as claimed in claim 11, wherein the MixColumns/InvMixColumns unit further performs a multiplied-by-8 operation on the multiplicand array to generate the multiplied-by-8 operation;
wherein the multiplied-by-8 operation is equivalent to three iterations of the multiplied-by-2 operation;
wherein the second verification unit determines whether the multiplied-by-8 operation is correct based on whether the multiplied-by-4 array and the multiplied-by-8 array conform to the mapping relationship;
wherein when the second verification unit determines that the multiplied-by-2 operation, the multiplied-by-4 operation, and the multiplied-by-8 operation are all correct, the second verification unit determines that the binary field multiplication operation performed by the MixColumns/InvMixColumns unit is correct.

13. The encryption/decryption device as claimed in claim 3, wherein the second verification circuit comprises:
a first divide-by-2 circuit, performing the divide-by-2 operation on a multiplied-by-2 array to generate the multiplied-by-2-and-divided-by-2 array;
a second divide-by-2 circuit, performing the divide-by-2 operation on a multiplied-by-4 array to generate the multiplied-by-4-and-divided-by-2 array;
a third divide-by-2 circuit, performing the divide-by-2 operation on a multiplied-by-8 array to generate the multiplied-by-8-and-divided-by-2 array;
a first comparator, comparing the multiplicand array and the multiplied-by-2-and-divided-by-2 array to generate a first result, wherein when the multiplicand array and the multiplied-by-2-and-divided-by-2 array are equal, the first result is at a first logic level;
a second comparator, comparing the multiplied-by-2 array and the multiplied-by-4-and-divided-by-2 array to generate a second result, wherein when the multiplied-by-2 array is equal to the multiplied-by-4-and-divided-by-2 array, the second result is at the first logic level;
a third comparator, comparing the multiplied-by-4 array and the multiplied-by-8-and-divided-by-2 array to generate a third result, wherein when the multiplied-by-4 array is equal to the multiplied-by-8-and-divided-by-2 array, the third result is at the first logic level; and
a logic gate, wherein when the first result, the second result, and the third result are all at the first logic level, the logic gate outputs the second verification signal being at the first logic level;
wherein the controller determines that the binary field multiplication operation performed by the MixColumns/InvMixColumns unit is correct based on the second verification signal being at the first logic level.

14. The encryption/decryption device as claimed in claim 13, wherein any one of the first divide-by-2 circuit, the second divide-by-2 circuit, and the third divide-by-2 circuit comprises:
a divide-by-2 circuit, configured to perform a divide-by-2 operation on an input array to generate an output array;
wherein the divide-by-2 circuit takes a first bit (i.e., the least significant bit) of the input array as an eighth bit (i.e., the most significant bit) of the output array;
wherein the divide-by-2 circuit takes an eighth bit (i.e., the most significant bit) of the input array as a seventh bit of the output array;
wherein the divide-by-2 circuit takes a seventh bit of the input array as a sixth bit of the output array;
wherein the divide-by-2 circuit takes a sixth bit of the input array as a fifth bit of the output array;
wherein the divide-by-2 circuit performs a mutually exclusive-OR operation on a fifth bit and the first bit of the input array to generate a fourth bit of the output array;
wherein the divide-by-2 circuit performs a mutually exclusive-OR operation on a fourth bit and the first bit of the input array to generate a third bit of the output array;
wherein the divide-by-2 circuit takes a third bit of the input array as a second bit of the output array;
wherein the divide-by-2 circuit performs a mutually exclusive-OR operation on a second bit and the first bit of the input array to generate a first bit (i.e., the least significant bit) of the output array.

15. The encryption/decryption device as claimed in claim 1, further comprising:
a dual addroundkey unit, performing a binary field addition operation on the mix-column/inverse mix-column array and a round key to generate the dual result data;
wherein when the result data is equal to the dual result data, the controller determines that the binary field addition operation performed by the addroundkey unit is correct;
wherein when the input state array is equal to the dual input state array, the controller determines that the row shift/inverse row shift operation performed by the ShiftRow/InvShiftRow unit is correct.

16. The encryption/decryption device as claimed in claim 2, further comprising:
a third verification unit, verifying a mapping relationship between the round key and the output state array to generate a third verification signal;
wherein the controller determines whether the mix column operation/inverse mix column operation performed by the MixColumns/InvMixColumns unit and the binary field addition operation are correct based on the third verification signal.

17. The encryption/decryption device as claimed in claim 16, wherein the third verification unit divides the output state array by byte to perform a mutually exclusive-OR operation so as to generate a simplified output state array;
wherein the third verification unit divides the round key by byte to perform the mutually exclusive-OR operation so as to generate a simplified round key;
wherein the third verification unit divides the result data by a number of bytes to perform the mutually exclusive-OR operation so as to generate a simplified result data;
wherein the third verification unit further performs the mutually exclusive-OR operation on the simplified output state array and the simplified round key to generate a first result;
wherein the third verification unit compares the first result with the simplified result data to generate the third verification signal;
wherein when the first result is equal to the simplified result data, the third verification signal is at the first logic level.

18. The encryption/decryption device as claimed in claim 16, wherein the third verification unit further comprises:
a first byte dividing device, dividing the output state array by byte to generate the divided output state array;
a first logic operation unit, performing a mutually exclusive-OR operation on the divided output state array to generate a simplified output state array;
a second byte dividing device, dividing the round key by a number of bytes to generate the divided round key;
a second logic operation unit, performing the mutually exclusive-OR operation on the divided round key to generate a simplified round key;
a third byte dividing device, dividing the result data by byte to generate the divided result data;
a third logic operation unit, performing the mutually exclusive-OR operation on the divided result data to generate a simplified result data;
a fourth logic operation unit, performing the mutually exclusive-OR operation on the simplified output state array and the simplified round key to generate a first result; and
a comparator, comparing the first result with the simplified result data to generate the third verification signal;
wherein when the first result is equal to the simplified result data, the third verification signal is at the first logic level.

19. An encryption/decryption method, comprising:
performing a row shift/inverse row shift operation on result data to generate an input state array;
performing a byte replacement/inverse byte replacement transformation on the input state array to generate an output state array;
performing the row shift/inverse row shift operation on dual result data to generate a dual input state array by using a dual ShiftRow/InvShiftRow unit;
encoding the dual input state array to generate encoded data;
decoding the encoded data to generate decoded data; and
determining whether the byte replacement/inverse byte replacement transformation is correct based on a mapping relationship of the decoded data and the output state array.

20. An encryption/decryption method, comprising:
performing a row shift/inverse row shift operation on result data to generate an input state array;
performing a byte replacement/inverse byte replacement transformation on the input state array to generate an output state array;
performing the row shift/inverse row shift operation on dual result data to generate a dual input state array by using a dual ShiftRow/InvShiftRow unit;
encoding the dual input state array to generate encoded data;
decoding the encoded data to generate decoded data;
performing a multiplied-by-2 operation on the output state array to generate a multiplied-by-2 array;
performing a divided-by-2 operation on the multiplied-by-2 array to generate a multiplied-by-2-and-divided-by-2 array; and
determining whether the byte replacement/inverse byte replacement transformation is correct based on a mapping relationship of decoded data and the multiplied-by-2-and-divided-by-2 array.
